(19) United States
(12) Patent Application Publication
(10) Pub. No.: US 2006/0167810 A1
(43) Pub. Date: Jul. 27, 2006

(54) Multi-merchant purchasing environment for downloadable products

(75) Inventors: Vikram Bhambri, Redmond, WA (US); Deirdre L. Walsh, Bellevue, WA (US); Paul C. Sausville, Issaquah, WA (US); Raj Biyani, Bellevue, WA (US); Thomas L. Button, Woodinville, WA (US); Sean Nolan, Bellevue, WA (US); Susan Warren, Point Richmond, CA (US); Matthew D. Hempey, Novato, CA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/042,916

(22) Filed: Jan. 24, 2005

(51) Int. Cl. G06F 17/60

(52) U.S. Cl. 705/59

(57) ABSTRACT

A multi-merchant purchasing system is configured to identify downloadable products selected by a user for purchase. The identified downloadable products are offered by multiple merchants. The multi-merchant purchasing system enables the user to purchase all of the downloadable products in a single transaction. Specifically, the multi-merchant purchasing system determines payment information associated with the user and, with minimum user-interaction, sends the payment information to applications associated with the merchants for processing. The multi-merchant purchasing system may also be configured to receive purchase information from the merchant applications and maintains the purchase information for the user in a locker. The multi-merchant purchasing system may further be configured to automatically download and install the purchased product onto the user's computing device through a software assistant. To ensure privacy and security, the multi-merchant purchasing system may include a credit card quarantine module to secure credit card data by encoding and multiple levels of encryptions.

### CROSS-REFERENCE TO RELATED APPLICATION(S)

This application is a continuation-in-part of a previously filed U.S. patent application Ser. No. 11/042,916, titled “MULTI-MERCHANT PURCHASING ENVIRONMENT FOR DOWNLOADABLE PRODUCTS”, the content of which is hereby incorporated by reference.

### BACKGROUND

As more and more businesses invest in online commerce infrastructure, purchasing products on the Internet continues to gain popularity among consumers. Shopping online has many advantages. For example, one advantage is that a consumer can browse, research and purchase products in an efficient manner without expending the time and effort of visiting physical stores. Another advantage is that online stores do not have the limitation of retail space and tend to have a better selection of products than physical stores.

One popular way for consumers to shop online is to visit an online equivalent of a department store. While an online department store may offer a variety of different products, the store often carries only products that are deemed to be profitable relative to business constraints, such as inventory, profit margins, etc. Consequently, the selection of products in any particular area may be limited. Also, an online department store may not be able to offer the best price for all of the products that it carries. Thus, if a consumer wants to purchase a particular product and at the best price, the consumer may have to visit multiple online department stores and specialty stores, which can be a time-consuming process.

To provide a better online shopping experience for consumers, many shopping services enable consumers to compare prices on products available on the Internet. These shopping services typically allow a consumer to search for a particular product that is offered by multiple stores and provide prices of the products at each store for comparison. In the comparison page, the price for each store is generally followed by a link to the store. A consumer may follow the link to visit the selected store and purchase the product. Although shopping services provide more selection and better prices for products, purchasing multiple products in this manner often involves substantial effort and is time-consuming. In particular, a consumer typically has to go through multiple purchasing processes.

An efficient way for consumers to purchase products from multiple merchants continues to elude those skilled in the art.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a multi-merchant purchasing system configured to identify downloadable products selected by a user for purchase. The identified downloadable products are offered by multiple merchants. The multi-merchant purchasing system enables the user to purchase all of the downloadable products in a single transaction. Merchant services are provided by the merchants to facilitate the purchasing of offered prodcts. Interfaces are provided by the multi-merchant purchasing system and merchant services for the system and the services to interact. The interfaces provided by the merchant services enable the multi-merchant purchasing system to obtain information such as item metadata, purchase summary data, locations for downloading the purchased products, locations for obtaining support, and download verification data. The interfaces provided by the multi-merchant purchasing system enable the merchant services to perform tasks such as revoking licenses for products, complete purchases, and add licenses to a locker that includes purchased products.

Many of the attendant features will be more readily appreciated as the same becomes better understood by reference to the following detailed description considered in connection with the accompanying drawings.

### DESCRIPTION OF THE DRAWINGS

These and other features and advantages of the present invention will be better understood from the following detailed description read in light of the accompanying drawings, wherein:

FIG. 1 shows an example multi-merchant purchasing system and related components.

FIG. 2 illustrates example communications associated with purchasing downloadable products with the multi-merchant purchasing system shown in FIG. 1.

FIG. 3 illustrates example communications associated with downloading products that are purchased through the multi-merchant purchasing system 100 shown in FIG. 1.

FIG. 4 illustrates another set of example communications associated with downloading purchased products.

FIG. 5 illustrates example communications for securely sending credit card numbers from a credit card quarantine module to a merchant service.

FIG. 6 shows example data that may be handled by the multi-merchant purchasing system shown in FIG. 1.

FIG. 7 shows example data that may be handled by the credit card quarantine module in FIG. 1.

FIG. 8 shows an example process for enabling a user to make a purchase in a multi-merchant purchasing environment.

FIG. 9 shows an example process for enabling a user to download products that are properly purchased.

FIG. 10 shows an example process for downloading a downloadable product purchased through a multi-merchant purchasing system.

FIG. 11 shows an example process for downloading and installing downloadable product purchased through a multi-merchant purchasing system.

FIG. 12 shows an example process for securely providing payment information to a merchant for purchasing downloadable products through a multi-merchant purchasing system.

FIG. 13 is a screenshot of an example user interface provided by a catalog provider for purchasing downloadable products from multiple merchants.

FIG. 14 is a screenshot of an example user interface for purchasing downloadable products through a multi-merchant purchasing system.

FIG. 15 is a screenshot of an example user interface for managing downloadable products newly purchased through a multi-merchant purchasing system.

FIG. 16 is a screenshot of an example user interface provided by a software assistant for downloading and installing products purchased through a multi-merchant purchasing system.

FIG. 17 is a screenshot of an example user interface provided by a locker of a multi-merchant purchasing system.

FIG. 18 is an example screenshot of a user interface provided by a multi-merchant purchasing system for a user to review purchases made with the system.

FIG. 19 is an example screenshot of a user interface provided by a multi-merchant purchasing system for a user to manage an account on the system.

FIG. 20 shows an exemplary computer device for implementing the described systems and methods.

FIG. 21 illustrates example communications between a multi-merchant purchasing system and merchant services.

FIG. 22 illustrates further example communications between a multi-merchant purchasing system and merchant services

### DETAILED DESCRIPTION

The systems, methods, and data structure described herein relates to an environment for purchasing items from multiple merchants. A multi-merchant purchasing system is configured to identify downloadable products selected by a user for purchase. The identified downloadable products are offered by multiple merchants. Typically, the user would have to make separate purchases with each of merchants and go through multiple purchasing processes. The multi-merchant purchasing system enables the user to purchase all of the downloadable products in a single transaction. Specifically, the multi-merchant purchasing system determines payment information associated with the user and, with minimum user-interaction, sends the payment information to applications associated with the merchants for processing. The multi-merchant purchasing system may also be configured to receive purchase information from the merchant applications and maintains the purchase information for the user in a locker. The multi-merchant purchasing system may further be configured to automatically download and install the purchased product onto the user's computing device through a software assistant. To ensure privacy and security, the multi-merchant purchasing system may include a credit card quarantine module to secure credit card data by encoding and multiple levels of encryptions. These and other aspects of the multi-merchant purchasing system will be discussed below in detail.

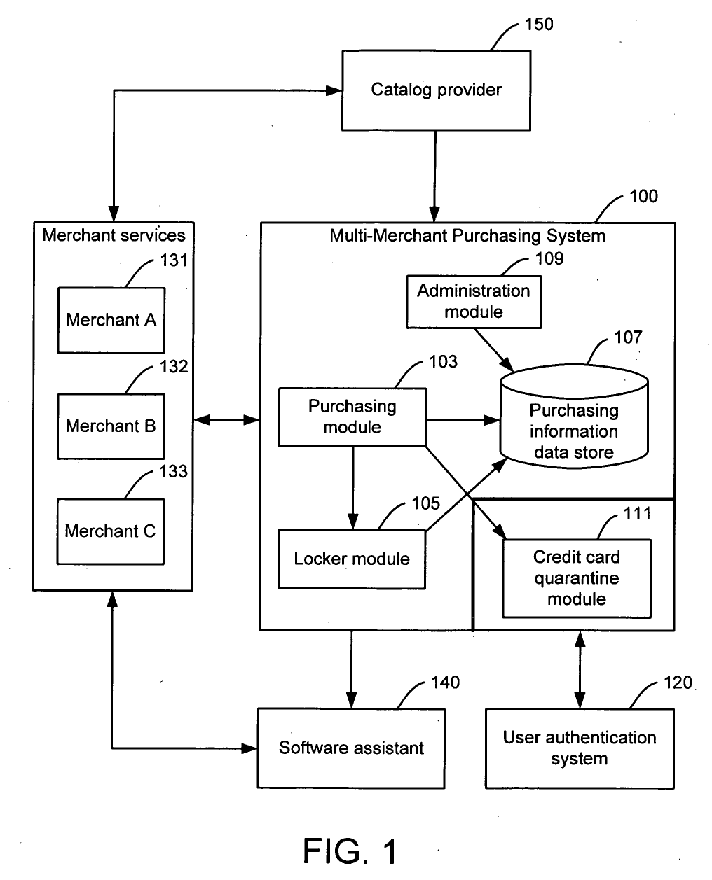

FIG. 1 shows an example multi-merchant purchasing system 100 and related components. Multi-merchant purchasing system 100 provides a centralized experience for a user/consumer to purchase, download, and manage products from multiple merchants. Multi-merchant purchasing system 100 may interact with multiple catalog providers, such as catalog provider 150, and to manage the purchasing aspects of a user's online shopping experience. Multi-merchant purchasing system 100 may also interact with merchant services 131-133 to obtain updated product information from merchants and to provide payment information to the merchants. Multi-merchant purchasing system 100 may interact with a user authentication system 120 to authenticate users before providing services. Multi-merchant purchasing system 100 may further interact with a software assistant 140 to provide content of purchased products for downloading and installation onto a user's device.

Catalog provider 150 is configured to provide an online shopping environment for users from which to select products. Catalog provider 150 typically includes a website that offers information about products from multiple merchants. Catalog provider 150 may be configured to interact with merchant services 131-133 to acquire and update information about the products.

Catalog provider 150 may be configured to enable a user to select products from different merchants for purchasing with a shopping cart utility. The utility may include a list of the selected products and some basic information about the products, such as the merchants that offer the products, the product serial numbers, or the like. When the user chooses to purchase the selected products, catalog provide 150 may be configured to provide information of the shopping cart utility to multi-merchant purchasing system 100, which handles the purchasing process. Although only catalog provider 150 is shown in FIG. 1, it is to be appreciated that multi-merchant purchasing system 100 may be configured to handle purchases from multiple catalog providers.

For ease of discussion, multi-merchant purchasing system 100 is illustrated as logical components and modules. As shown in FIG. 1, multi-merchant purchasing system 100 may include purchasing module 103, locker module 105, credit card quarantine module 111, administration modules 109, and purchasing information data store 107.

Purchasing module 103 is configured to handle the purchasing aspects of the functionalities provided by multi-merchant purchasing system 100. Purchasing module 103 presents a user-interface for a user to purchase downloadable products from multiple merchants with a single transaction. Particularly, purchasing module 103 enables a user to purchase downloadable products from multiple merchants by going through the purchasing process only once. For example, multi-merchant purchasing system 100 enables the user to purchase products from each of the merchants corresponding to merchant services 131-133 by presenting the purchases to the user as a single transaction.

Purchasing module 103 is configured to receive from other services, such as catalog provider 150, shopping cart information that identifies downloadable products to be purchased by a user. Purchasing module 103 may interact with user authentication system 120 to authenticate the user prior to the purchasing process. The shopping cart information typically includes a list of the selected products to be purchased, the merchants that offer the products, serial numbers, availability, prices, or other basic information about the products.

Catalog provider 150 typically allows merchant services 131-133 to provide product information in a periodic basis. Thus, depending on timing, the shopping cart information provided by catalog provider 150 to purchasing module 103 may not be up to date. If necessary, purchasing module 103 is configured to interact with merchant services 131-133 to obtain updated certain information about the product, such as availability, pricing, or the like.

To perform the purchasing process, purchasing module 103 typically prompts the user to provide transactional information related to purchasing the downloadable products, such as personal information, shipping information, payment information, or the like. Multi-merchant purchasing system 100 typically does not handle payment transactions. Purchasing module 103 is configured to provide the transactional information to merchant services 131-133 for purchasing downloadable products from each of the merchants. Before allowing the user to provide the transactional information, multi-merchant purchasing system 100 is configured to alert the user that the provided information will be sent to the merchants for processing. Purchasing module may also be configured to record the transactional information for the user and apply the information for subsequent purchases without asking to user to provide the information again.

Upon receiving credit card payment information from the user, purchasing module 103 may be configured to safeguard the credit card number by immediately sending the number to credit card quarantine module 111. To ensure security, purchasing module 103 may also be configured to immediately delete any records of the credit card number. Purchasing module 103 is configured to receive a token from credit card quarantine module 111 to represent the credit card number. The token may be stored along with other credit card information for the user in purchasing information data store 107. To provide payment information of the user to a merchant, purchasing module 103 is configured to send the token to credit card quarantine module 111 along an identifier of the merchant. In response, purchasing module 103 receives from credit card quarantine module 111 a credit card number that is encrypted with a public key associated with the merchant to which the number will be forwarded. Purchasing module 103 is configured to provide the encrypted credit card number to the merchant service associated with the merchant along with other transactional information.

After a payment transaction has been completed by a merchant service for the purchase of a downloadable product, purchasing module 103 is configured to receive purchasing information related to the purchased product from the merchant service. Purchasing information may include license information of the product, key to activate the product, warranty, support, or the like. Purchase module 103 is configured to store the purchasing information in the purchasing information data store 107.

Locker module 105 enables users to manage and access downloadable products purchased through multi-merchant purchasing system 100. Locker module 105 is configured to interact with purchasing information data store 107 to retrieve purchasing information associated with the users. Locker module 105 may provide various types of information about purchased products to the users, such as license information of the products, purchase history, estimated downloading time for the products, warranty information, or the like.

Locker module 105 is configured to interact with software assistant 140 to enable a user to download a newly purchased product. Subsequent to the initial downloading, depending on the license acquired, locker module 105 may enable the user to perform other processes related to the downloadable product, such as repeated downloading of the product, downloading the product onto another computer, or the like. In one embodiment, locker module 105 retains information of all purchased products associated with a user's computing device. Locker module 105 may enable to the user to automatically download and install the purchased products onto the computer device through software assistant 140. Locker module 105 is configured to enable software assistant 140 to download products from a link provided by merchant services 131-133, but is not typically configured to provide the content of the downloadable product directly to software assistant 140.

Credit card quarantine module 111 is configured to store and safeguard credit card numbers for multi-merchant purchasing system 100. Credit card quarantine module 111 may be implemented as a part of the multi-merchant purchasing system 100 or as a separate component. Credit card quarantine module 111 is configured to receive credit card number from purchasing module 103 and to prevent the number from being sent out without encryption. Credit card quarantine module 111 is configured to generate tokens for each received credit card number and to associate each number with the corresponding token. The tokens are provided to purchasing module 103 for storing with other information associated with the user and a particular transaction. Credit card quarantine module 111 may also determine public/private key pairs where each pair of keys corresponds to each merchant associated with multi-merchant purchasing system 100. Credit card quarantine module 111 is configured to provide each private key to the corresponding merchant and to encrypt credit card numbers with the corresponding public key before sending the numbers to the merchant.

Purchase information data store 107 typically includes purchase information associated with transactions for each user. Purchase information data store 107 may be implemented as a database system for use by components of multi-merchant purchasing system 100. For example, purchase information data store 107 may be implemented as a Structured Query Language (SQL) database system. Administrative module 109 is configured to allow a system administrator to maintain multi-merchant purchasing system 100. For example, administrative module 109 may enable a system administrator to manage purchasing information data store 107.

User authentication system 120 is configured to enable a user to be authenticated prior to purchasing downloadable products on multi-merchant purchasing system 100. Any type of user authentication system may be used. For example, user authentication system 120 may include a MICROSOFT® PASSPORT system.

Software assistant 140 is configured to enable a user to download products purchased on multi-merchant purchasing system 100. Software assistant 140 is typically implemented as an application on a user's computing device. Software assistant 140 interacts with locker module 105 to determine which downloadable products are available for downloading and the locations at which the products can be downloaded. Software assistant 140 is configured to download the products at the determined locations, which are typically maintained by merchant services 131-133. Software assistant 140 is also configured to calculate a hash of a downloaded product for authentication purposes. For example, the hash may be compared with another hash determined by the merchant service that provided the product to determine whether the downloaded product is valid. The downloaded product may be invalid due to a variety of reasons, such as data corruption, substitution, hacking, or the like. The comparison may be performed by software assistant 140 or multi-merchant purchasing system 100.

Software assistant 140 is also configured to install downloaded products into the user's computing device. In one embodiment, software assistant 140 is configured to interact with locker module 105 to automatically download and install the purchased products associated with a computer device. In this manner, the computer device may be automatically imaged with the purchased products with minimum effort by the user.

Merchant services 131-133 are configured to receive transactional information from multi-merchant purchasing system 100 and to perform operations related to purchasing of downloadable products offered by the merchants. Merchant services 131-133 may be configured to provide any type of downloadable products, such as software, music, videos, graphics, or other type of digital content. The merchants corresponding to merchant services 131-133 may include any type of entities, such as producers of the downloadable products, online retailers, resellers, or the like. In particular, merchant service 131-133 may also be configured to serve as catalog providers.

Each of the merchant services 131-133 is configured to use payment information received form multi-merchant purchasing system 100 to arrange for payment for the downloadable products. In particular, each of the merchant services 131-133 is configured to receive from multi-merchant purchasing system 100 encrypted credit card numbers to process payments. Each of the merchant services 131-133 processes a private key provided by multi-merchant purchasing system 100 to decrypt the credit card numbers that are encrypted by credit card quarantine module 111.

After receiving payment, merchant services 131-133 are configured to provide multi-merchant purchasing system 100 with purchasing information, such as software licenses, receipt, shipping tracking number, downloading location, activation keys, or the like. Merchant services 131-133 may be configured to make the product available to the user for downloading in any manner, such as through downloading manager 140. Merchant services 131-133 may be configured to provide a hash value of the downloaded product for verification.

Catalog providers 150, merchant services 131-133, modules of multi-merchant purchasing system 100, software assistant 140 and user authentication system 120 may be implemented as any type of applications, such as web services. The term “web service” or “application service” means an application that is capable of interacting with other applications through one or more protocols, such as network protocols. Typically, web services are configured to send data to and receive data from applications through any type of networks. A web service may be identified by an identifier, such as an Internet Protocol (IP) address or a Uniform Resource Locator (URL), so that other applications can readily locate and communicate with the web service.

Web services may also be configured to facilitate communication between applications that are executing on difference types of devices and operating environments. Web services may communicate with other applications using various universal standards. For example, web services may use Extensible Markup Language (XML) to tag data, Simple Object Access Protocol (SOAP) to transfer the data, Web Services Description Language (WSDL) to describe the services available, or Universal Description, Discovery and Integration (UDDI) to list what services are available. The web services may be implemented in any type of software code, such as XML.

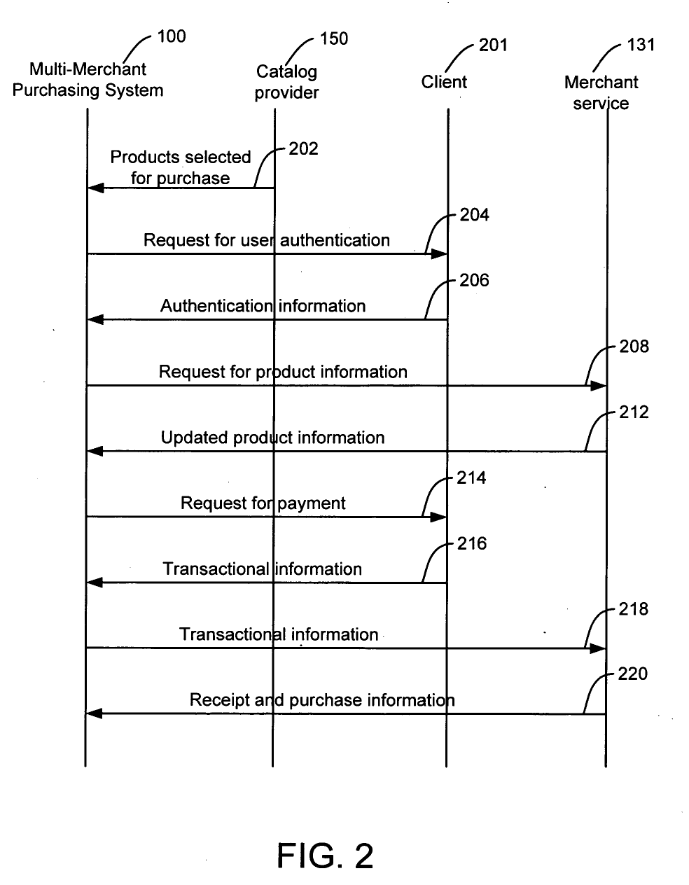

FIG. 2 illustrates example communications associated with purchasing downloadable products with multi-merchant purchasing system 100 shown in FIG. 1. For the purpose of discussion, a user has selected downloadable products through catalog provider 150 from a number of merchants, which include the merchant that corresponds to merchant service 131.

When the user chooses to purchase the downloadable products in the shopping cart, catalog provider 150 may send message 202 to multi-merchant purchasing system that includes the shopping cart information. The shopping cart information may include information about the products, such as serial numbers, the merchants associated with the products, description, prices, or the like. In response, multi-merchant purchasing system 100 may send message 204 to client 201 associated with the user that includes a request for user authentication. Multi-merchant purchasing system 100 may perform user authentication with client 201 or another computing device that includes a user authentication system. In response, client 201 (or the other computing device) may send message 206 that includes authentication information of the user.

Multi-merchant purchasing system 100 may send message 208 that includes a request for product information to merchant service 131. Message 208 may be sent if the product information determined by multi-merchant purchasing system 100 is not valid or has expired. In response, merchant service 131 may send message 212 that includes updated product information. Multi-merchant purchasing system 100 may present the information to the user prior to finalizing the purchase.

Multi-merchant purchasing system 100 may send message 214 to the client to request for payment. In response, client 201 may send message 216 that includes transactional information. The transactional information may include payment information, such as a credit card number, expiration date, security code, name, home address, phone number, or the like. The transactional information may also include other purchase-related information, such as shipping address, instructions, or the like. Message 216 may not be necessary if the multi-merchant purchasing system 100 has such transactional information from prior interaction with the user and is authorized to provide such information to merchants. Multi-merchant purchasing system 100 may send message 218 that includes transactional information to merchant service 131. After performing payment related transactions, merchant service 131 may send message 220 that includes a receipt and purchase information associated with the purchased products. For example, the purchase information may include licensing information, warranty information, shipping information, downloading location, or the like.

For illustrative purposes, only communications with a single merchant are shown for this purchase. It is to be appreciated that the purchase may include downloadable products from multiple merchants and communications with these merchants may be performed similar to those illustrated in FIG. 2.

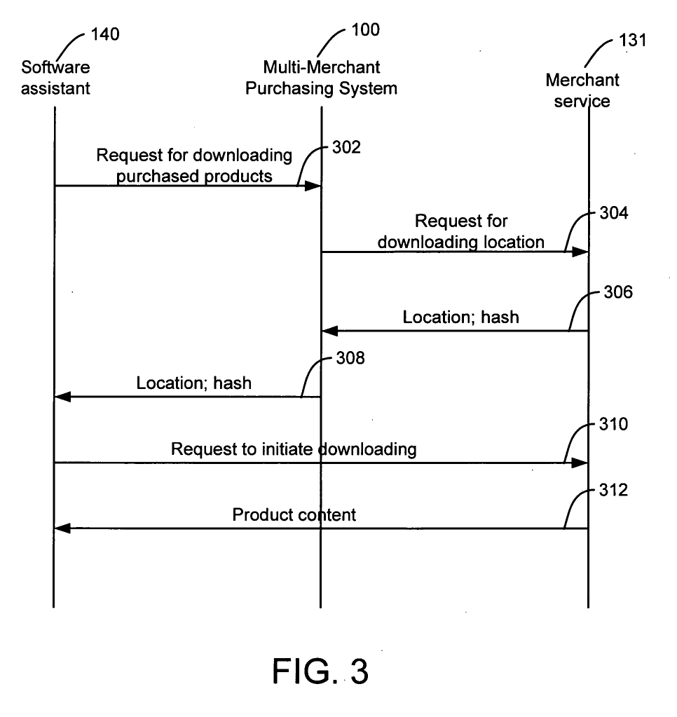

FIG. 3 illustrates example communications associated with downloading products that are purchased through multi-merchant purchasing system 100 shown in FIG. 1. A user may employ a software assistant 140 to obtain the downloadable products. Software assistant 140 may send message 302 that includes a request for downloading purchased products to multi-merchant purchasing system 100. In response, multi-merchant purchasing system 100 may send message 304 that includes a request for downloading location to merchant service 131.

Merchant service 131 may send message 306 that includes a downloading location for the purchased products and a hash value associated with the products. The location may include an address, such as a Universal Resource Locator (URL), an Internet Protocol (IP) address, or the like. Multi-merchant purchasing system 100 may send message 308 with the downloading location and the hash value to software assistant 140. Software assistant 140 may send message 310 that includes a request to initiate downloading. In response, merchant service 312 may provide the product content in message 312.

After receiving the product content, software assistant 140 may calculate a hash value from the content and compare the calculated hash value with the value received in message 308. If the hash values do not match, the received content would be determined to have been compromised and would be invalidated. The communications in FIG. 3 show that software assistant 140 is configured to compare the hash values. It is to be appreciated that the software assistant 140 may also be configured to provide the calculated hash to multi-merchant purchasing system 100 for comparison.

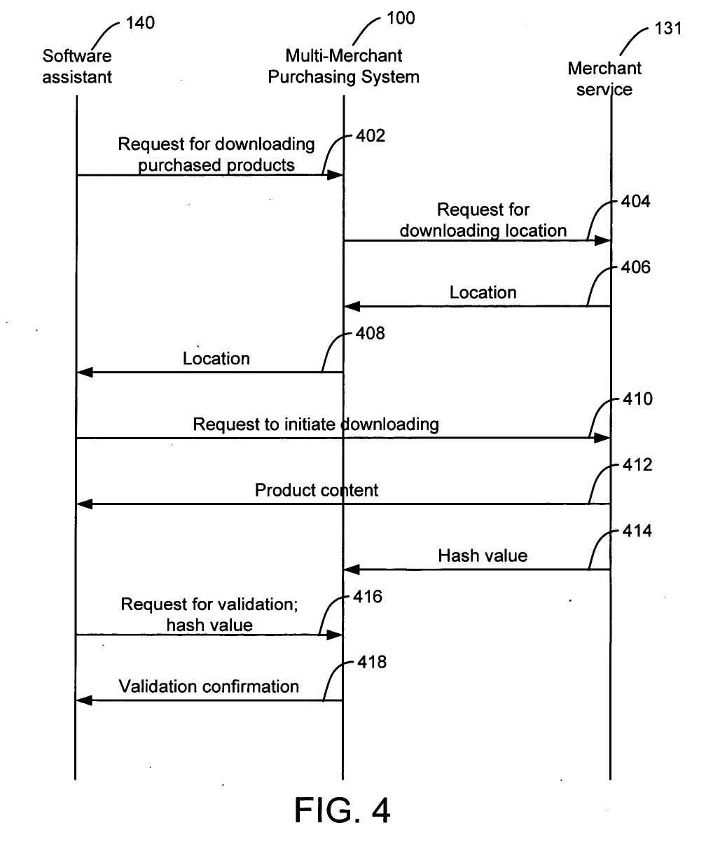

FIG. 4 illustrates another set of example communications associated with downloading purchased products. The example communications shown in FIG. 4 are somewhat similar to the example communication shown in FIG. 3. The differences in the communications account for the fact that merchant service 131 does not provide the hash value at the time the downloading location is provided.

As shown in FIG. 4, software assistant 140 may send message 402 that includes a request for downloading purchased products to multi-merchant purchasing system 100. In response, multi-merchant purchasing system 100 may send message 404 that includes a request for downloading location to merchant service 131.

Merchant service 131 may send message 406 that includes a downloading location for the purchased products. Multi-merchant purchasing system 100 may send message 408 with the downloading location to software assistant 140. Software assistant 140 may send message 410 that includes a request to initiate downloading. In response, merchant service 412 may provide the product content in message 412.

After providing the product content to software assistant 140, merchant service 131 may send message 414 that includes a hash value associated with the product content to multi-merchant purchasing system 100. Software assistant 140 may calculate a hash value from the product content received in message 412 and send message 416 that includes the calculated hash value and a request for validation to multi-merchant purchasing system 100. Multi-merchant purchasing system 100 may compare the hash values received in message 414 and message 416. If the hash values match, multi-merchant purchasing system 100 may send message 418 that includes a validation confirmation to software assistant 140.

The communications in FIG. 4 show that multi-merchant purchasing system 100 is configured to compare the hash values. It is to be appreciated that multi-merchant purchasing system 100 may also be configured to provide the hash value received in message 414 to software assistant 140 for comparison.

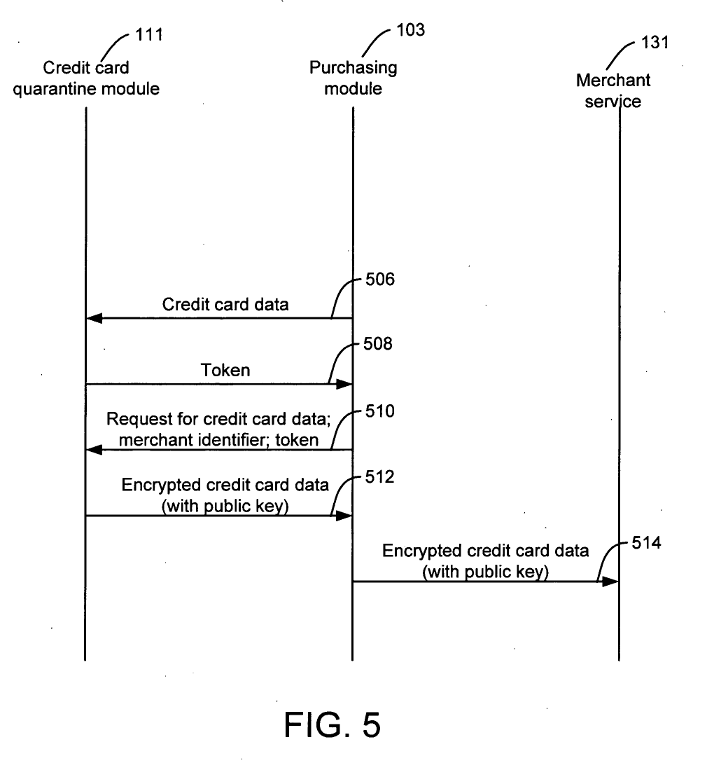

FIG. 5 illustrates example communications for securely sending credit card numbers from credit card quarantine module 111 to merchant service 131. To prepare for secured transfer of credit card numbers, credit card quarantine module 111 and merchant service 131 may establish a public/private key arrangement so that communications between quarantine module 111 and merchant service 131 may be encrypted.

When the purchasing module 103 receives credit card data, such as a credit card number and related information, purchasing module 103 sends message 506 to credit card quarantine module 111 with the credit card data. In response, the credit card quarantine module 111 may return a token to represent the credit card data to purchasing module 103 with message 508.

When the purchasing module 103 determines to send the credit card data to merchant service 131, the purchasing module 103 may send message 510 that includes a request for credit card data along with the identity of the merchant to which the data will be sent and the token corresponding to the credit card data. In response, credit card quarantine module 111 may send message 512 that includes the requested credit card data encrypted with a public key corresponding to the merchant. Purchasing module 103 may send message 514 that includes the encrypted credit card data to merchant service 131. The merchant service may decrypt the credit card data using the corresponding private key.

The example communications in FIG. 2-5 may be structured in any manner, such as encoded as web service communications. To enhance security, the example communications may also be encrypted using any encryption algorithms and methods. Thus, the content of the messages, such as credit card data, may be secured with multiple levels of encryption.

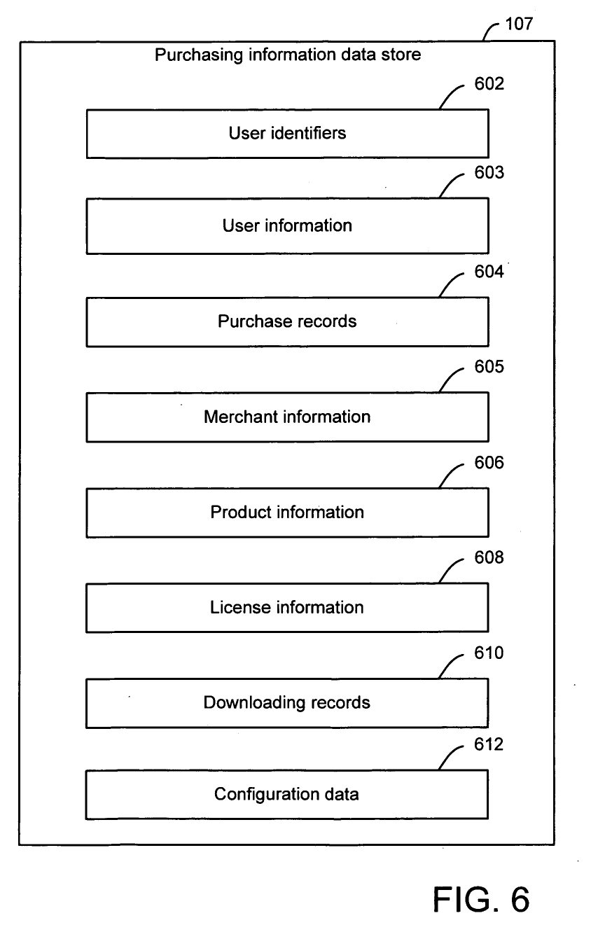

FIG. 6 shows example data that may be handled by multi-merchant purchasing system 100 shown in FIG. 1. The example data in FIG. 6 is shown to be included in purchased information data store 107. The example data may also be included in any data structure and communications between multi-merchant purchasing system 100 and other components, such as merchant services 131-133 and software assistant 140 shown in FIG. 1.

As shown in FIG. 6, purchasing information data store 107 may include user identifiers 602, user information 603, purchase records 604, merchant information 605, production information 606, license information 608, downloading records 610, and configuration data 612.

User identifiers 602 identify users that are associated with multi-merchant purchasing system 100. User identifiers 602 may serve as an indexing field for structuring other data in the data store 107. User information 603 includes information about each user identified by user identifiers 602. User information 603 may include personal information, such as name, address and phone number, payment information, or the like.

Purchase records 604 include records of purchases made by the users indicated by user identifiers 602. Each entry of the purchase records 604 may include a transaction number, date and time, a list of products, prices, or the like. Purchase records 604 may serve as an indexing field for structuring other data related to purchases. Merchant information 605 may include information about the merchant from which downloadable products were purchased in a particular transaction indicated in purchase records 604. Product information 606 may include detail information about the purchased products. License information 608 includes data about the licenses of the purchased products. For example, license information may include license numbers, keys, descriptions, restrictions, or the like. Downloading records 610 may include records of downloading event for products of each purchase. Configuration data 612 may include configurations of purchased products for a computing device associated with each user indicated in user identifiers 602. Configuration data 612 may be used to automatically image a user's computing device with downloadable products purchased through multi-merchant purchasing system 100.

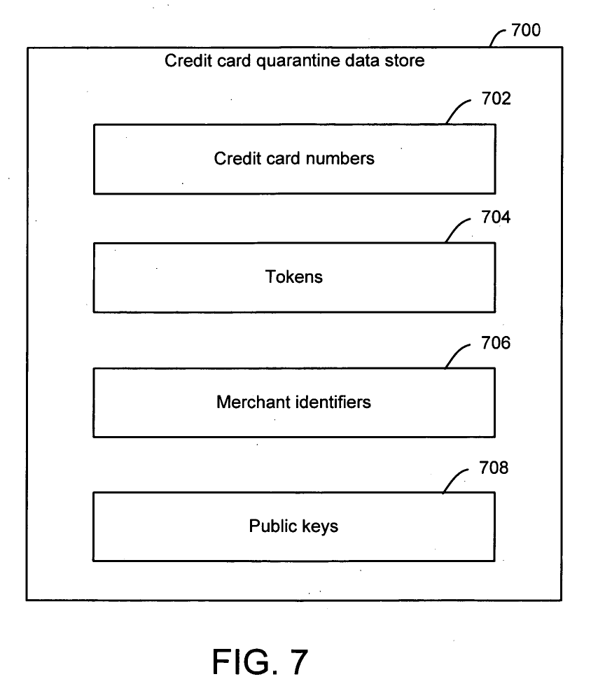

FIG. 7 shows example data that may be handled by credit card quarantine module 111 in FIG. 1. As shown in FIG. 7, the example data may be included in credit card quarantine data store 700. The example data may include credit card numbers 702, tokens 704, merchant identifiers 706 and public keys 708. Tokens 704 are associated with credit card numbers 702. Each of the tokens 704 may be provided to another component, such as purchasing module 103 in FIG. 1, to reference a corresponding number in credit card numbers 702. Public keys 708 are associated with merchant identifiers 706. Each of the public keys 708 is used to encrypt credit card numbers before the numbers are transmitted to the merchant corresponding to one of the merchant identifiers 706.

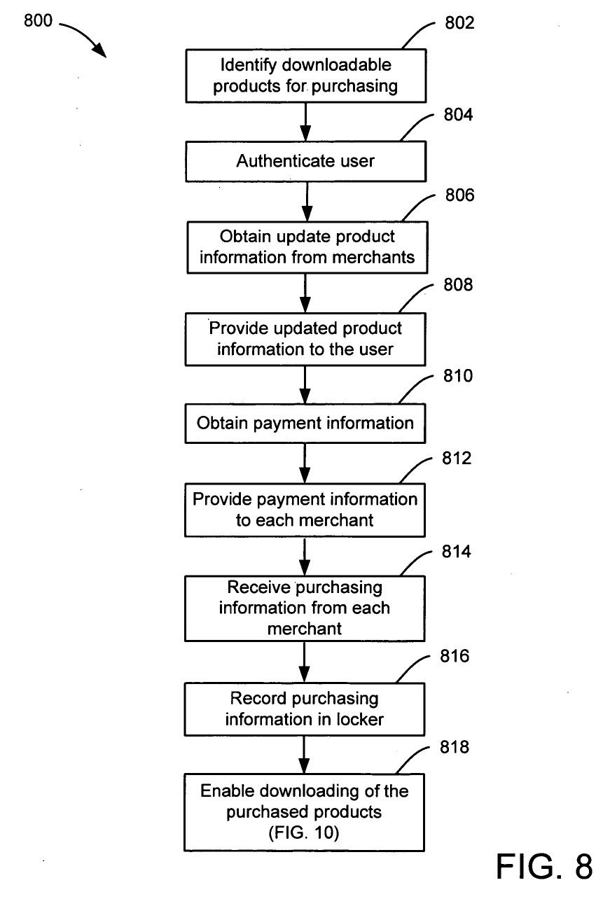

FIG. 8 shows an example process 800 for enabling a user to make a purchase in a multi-merchant purchasing environment. For example, process 800 may be implemented by a multi-merchant purchasing system to allow a user to purchase downloadable products from multiple merchants with a single transaction. At block 802, the downloadable products for purchasing are identified. The downloadable products may be identified from data provided by one or more catalog providers. At block 804, the user who is purchasing the downloadable products is authenticated. At block 806, updated product information about the downloadable products is obtained from merchants that offer the downloadable products. At block 808, the updated product information is provided to the user. At block 810, payment information is obtained. The payment information may be provided by the user or may be retrieved from a data store that contains the information, such as if the user has already provided the information in a previous purchase.

At block 812, payment information is provided to each merchant by which the downloadable products to be purchased are offered. At block 814, purchasing information from each merchant is received. At block 816, the purchasing information is recorded in a locker associated with the user. At block 818, the user is enabled to download the purchased products.

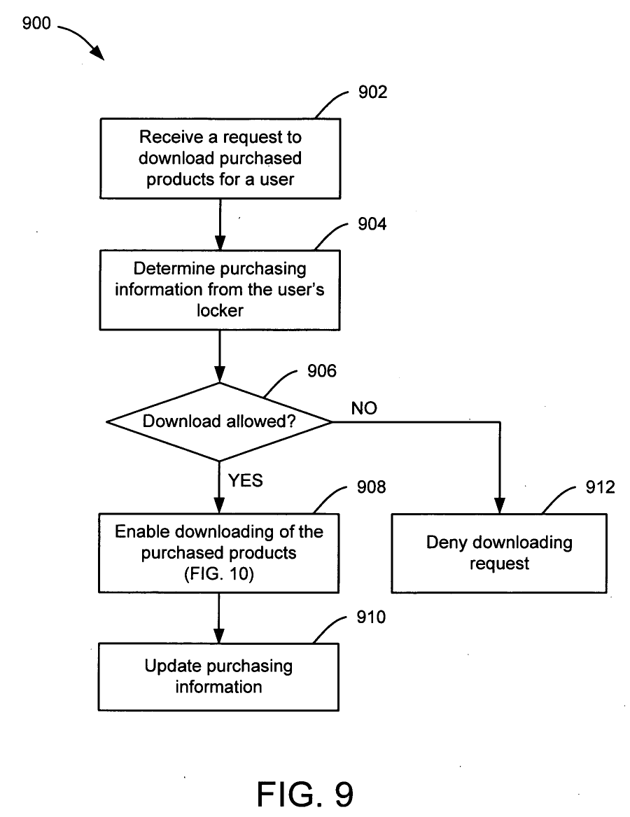

FIG. 9 shows an example process 900 for enabling a user to download products that are properly purchased. Process 900 may be implemented by a multi-merchant purchasing system to interact with a software assistant in a user's computing device. At block 902, a request to download purchased products for a user is received from a software assistant. The purchased products may be provided by different merchants. The request may be for downloading the purchased products for the first time or for a repeated downloading. At block 904, purchasing information from the user's locker is determined. At decision block 906, a determination is made whether downloading is allowed. The determination may be determined based on the licenses of the purchased products. If downloading is not allowed, process 900 moves to block 912 where the downloading request is denied.

Returning to decision block 906, if downloading is allowed, process 900 moves to block 908 where the user is enabled to download the purchased products. At block 910, the purchasing information is updated to reflect the downloading.

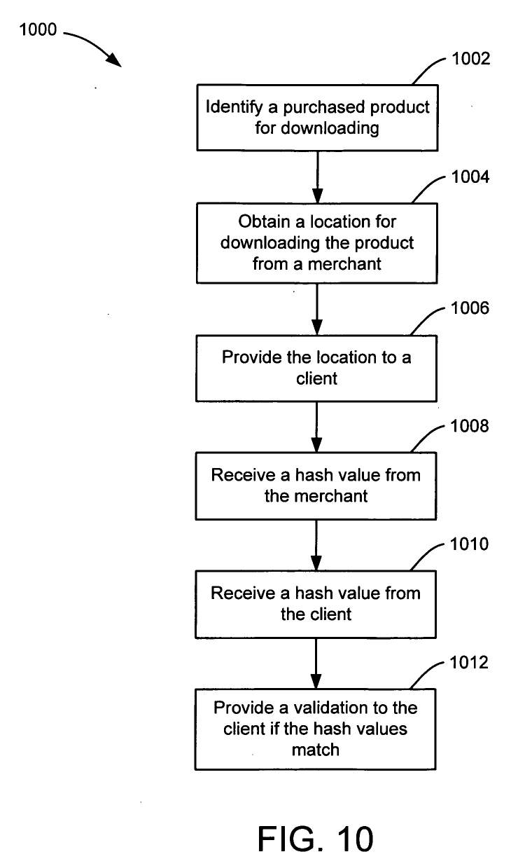

FIG. 10 shows an example process 1000 for downloading a downloadable product purchased through a multi-merchant purchasing system. At block 1002, the purchased product for downloading is identified. At block 1004, a location for downloading the product is obtained from the merchant by which the product is provided. The location typically includes a URL, IP address, or other identifier of a location in a network.

At block 1006, the location is provided to a client that requests the downloading. At block 1008, a hash value derived from the product for downloading is received from the merchant. At block 1010, another hash value calculated by the client is received from the client. At block 1012, a validation is provided to the client if the hash values match.

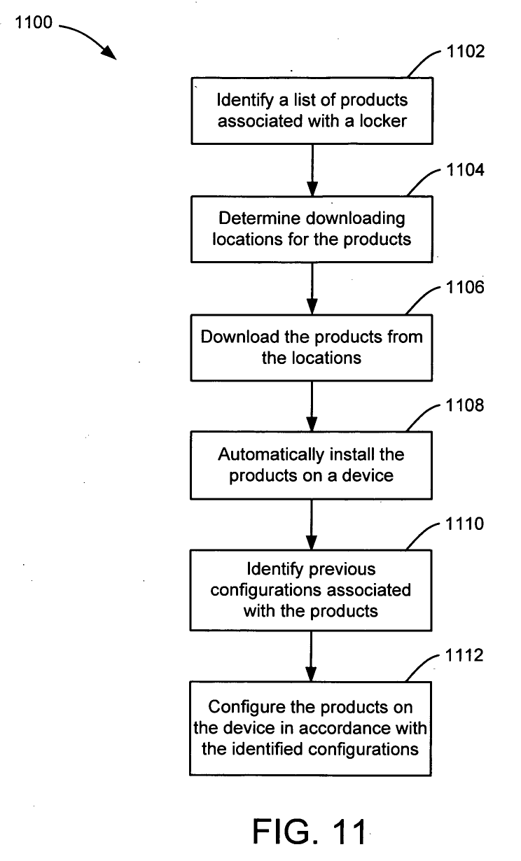

FIG. 11 shows an example process 1100 for downloading and installing product purchased through a multi-merchant purchasing system. Process 1100 may be implemented by a software assistant. At block 1102, a list of products associated with a locker on the multi-merchant purchasing system. The locker is typically associated with a user. The products may be provided by multiple merchants. At block 11104, downloading locations for the products are determined. Each location corresponds to a service of a merchant that provides at least one of the products. At block 1106, the products are downloaded from the locations. At block 1108, the products are automatically installed on the computing device associated with the user.

For repeated downloading, the steps in blocks 1110 and 1112 may be used to configure the downloaded products. At block 1110, previous configurations associated with the products are identified. At block 1112, the products on the device are configured in accordance with the identified configurations. The steps in blocks 1110 and 1112 may be used to automatically image the computing device with software and data that are purchased from the multi-merchant purchasing system.

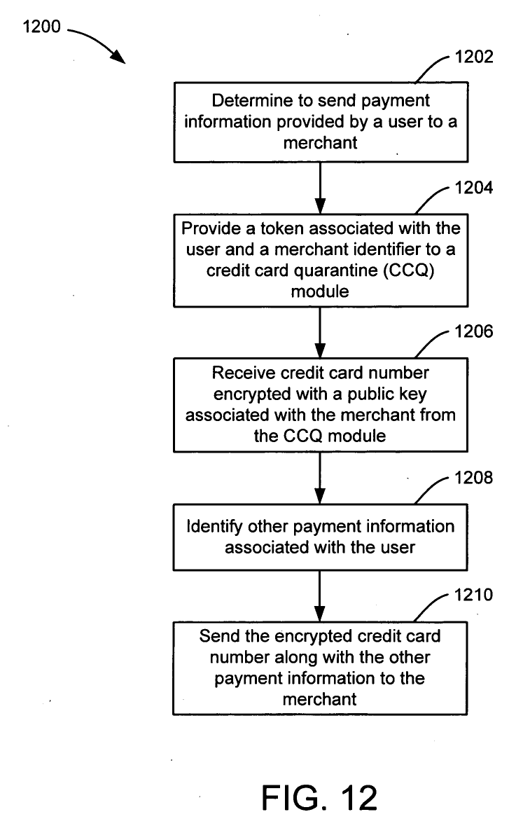

FIG. 12 shows an example process 1200 for securely providing payment information to a merchant for purchasing downloadable products through a multi-merchant purchasing system. At block 1202, the process determines to send payment information provided by a user to a merchant. At block 1204, a token associated with the user and a merchant identifier is provided to a credit card quarantine module. At block 1206, credit card number encrypted with a public key associated with the merchant indicated by the merchant identifier is received from the credit card quarantine module. At block 1208, other payment information associated with the user is identified. For example, the other payment information may include a name, address, expiration date, security code, phone number, address, or the like. At block 1210, the encrypted credit card number is sent to the merchant along with the other payment information.

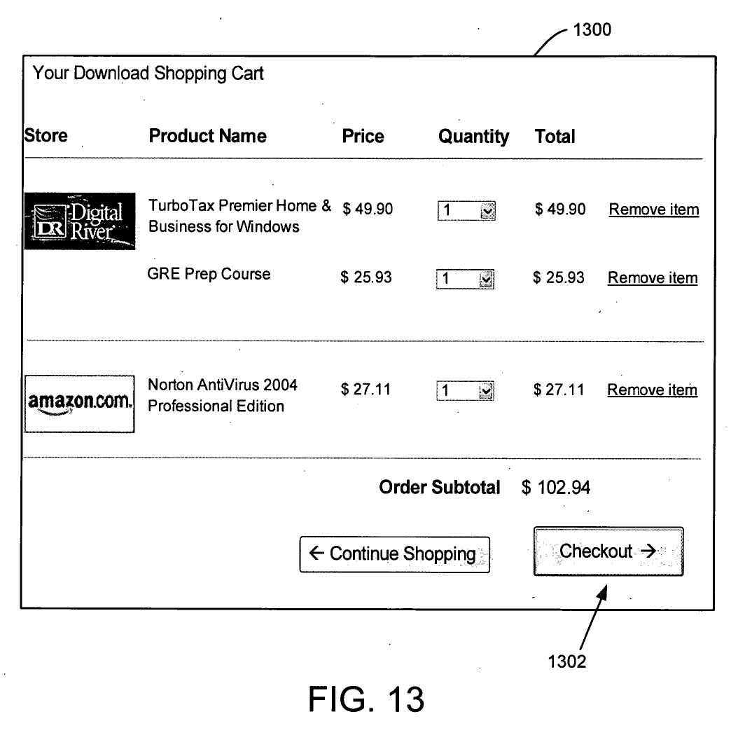

FIG. 13 is a screenshot 1300 of an example user interface provided by a catalog provider for purchasing downloadable products from multiple merchants. As shown in example screenshot 1300, a shopping cart associated with a user is presented. The shopping cart includes downloadable products from two different merchants. The user may proceed to purchase the downloadable product with a multi-merchant purchasing system by activating checkout button 1302.

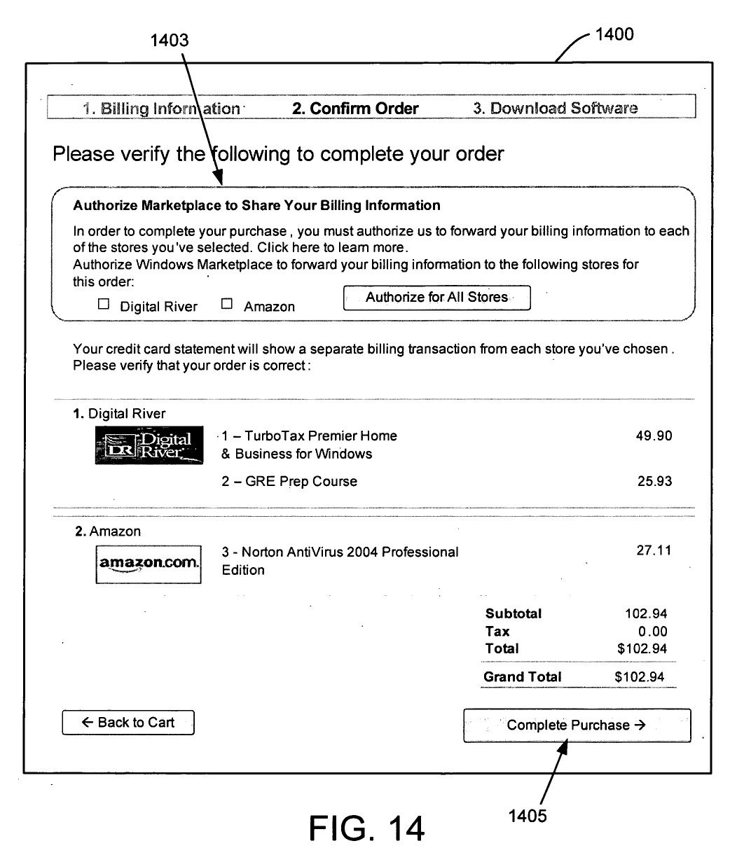

FIG. 14 is a screenshot 1400 of an example user interface for purchasing products through a multi-merchant purchasing system. As shown in FIG. 14, the products from multiple merchants illustrated in FIG. 13 are listed for the user. The information may include updated information, such as prices, description, or the like, provided by each merchant. An authorization selection area 1403 is provided to show the user that the payment information will be provided to each merchant for processing and to enable the user to provide authorization. The user may provide the necessary authorization in area 1403 and complete the purchase by activating the complete purchase button 1405. Upon activation, the payment information and other transactional information would be provided to each merchant for processing.

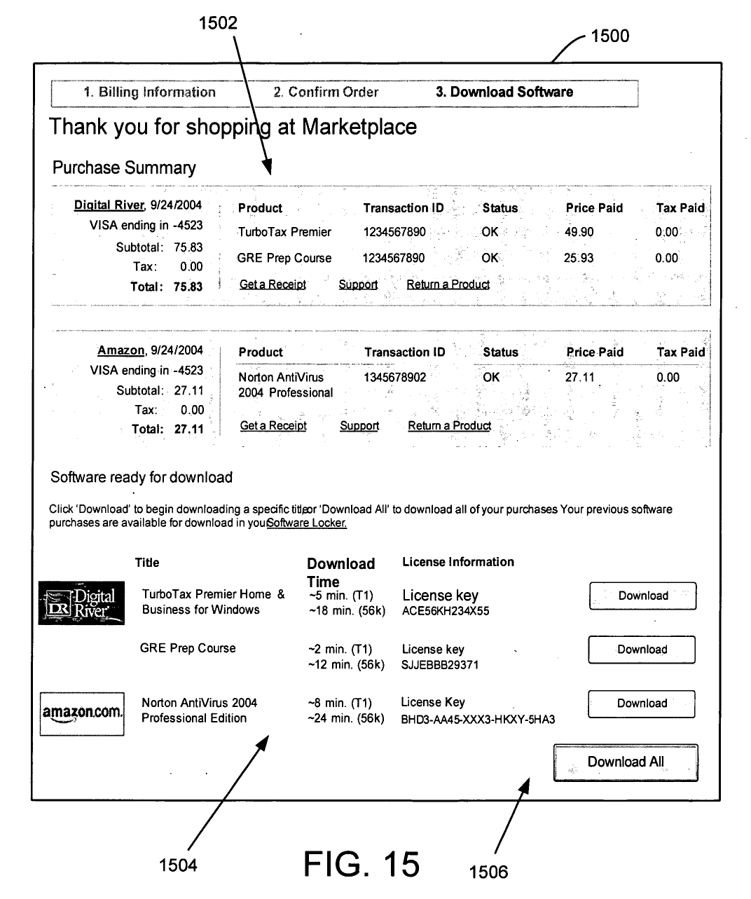

FIG. 15 is a screenshot 1500 of an example user interface for managing downloadable products newly purchased through a multi-merchant purchasing system. In area 1502, information about a purchase is presented. As shown in the figure, downloadable products from two different merchants are included in the purchase. In area 1504, the information about the purchased products is shown. The information includes license information associated with the downloadable products. Downloading times are also provided for review by the user. The user may select to start the downloading process by activating a download button 1506. Upon activation, a software assistant may be launched on the user's computing device to perform the downloading.

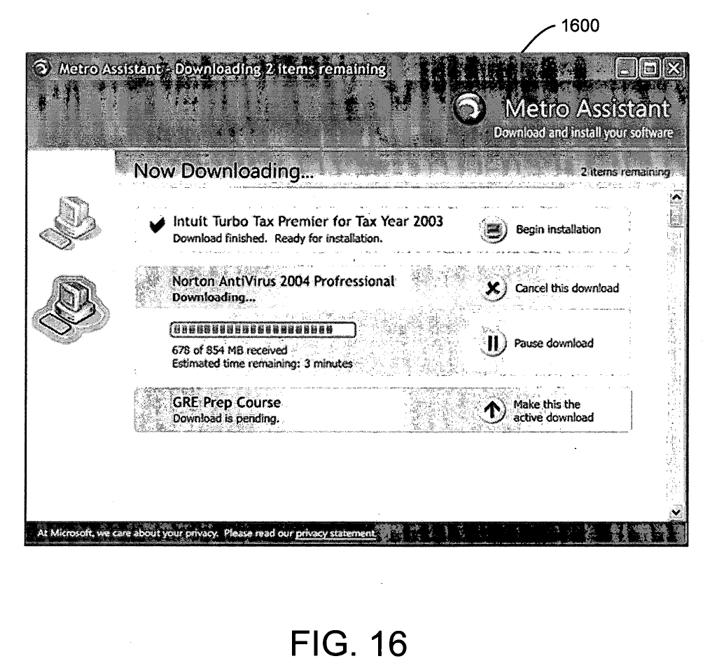

FIG. 16 is a screenshot 1600 of an example user interface provided by a software assistant for downloading and installing products purchased through a multi-merchant purchasing system. The software assistant is typically a client process executing on the user's computing device. The software assistant typically interacts with the multi-merchant purchasing system to obtain information for downloading and with a merchant service to receive the actual product content. As shown in screenshot 1600, the software assistant may be configured to download multiple products from different merchants at the same time. The software assistant may also be configured to install the downloaded products.

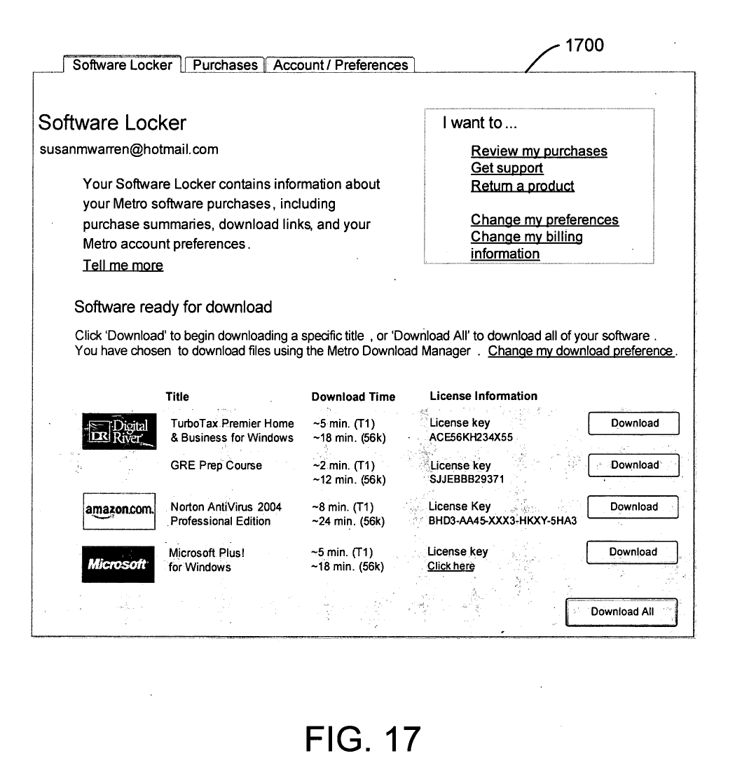

FIG. 17 is a screenshot 1700 of an example user interface provided by a locker of a multi-merchant purchasing system. The locker enables a user associated with the locker to access the downloadable products purchased through the multi-merchant purchasing system. As shown in screenshot 1700, the locker may provide purchase information, such as a list of the purchased products, license information, downloading time, or other information. Depending on the licenses, the locker may also enable to the user to download the purchase products again after the initial download.

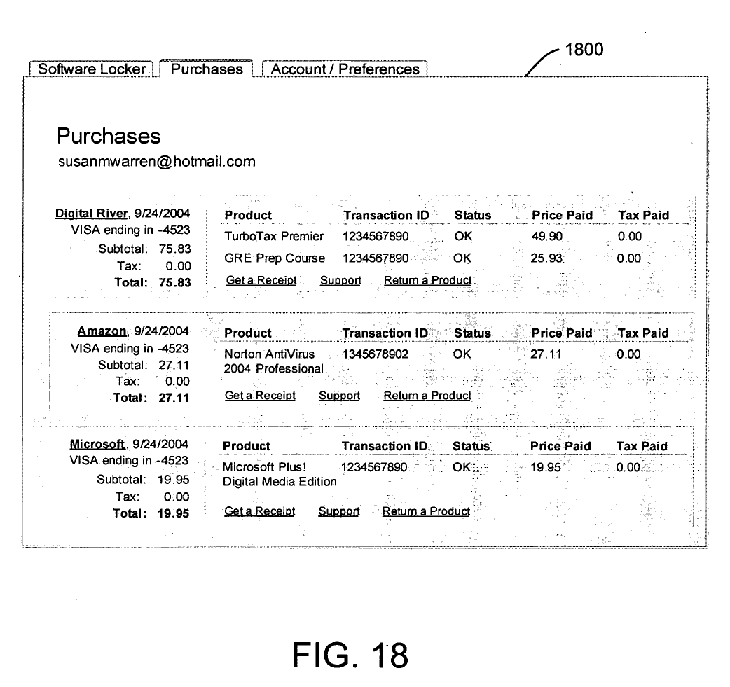

FIG. 18 is an example screenshot 1800 of a user interface provided by a multi-merchant purchasing system for a user to review purchases made with the system. As shown in FIG. 18, purchases from multiple merchants may be shown together. Also, links are available for obtaining additional information and support.

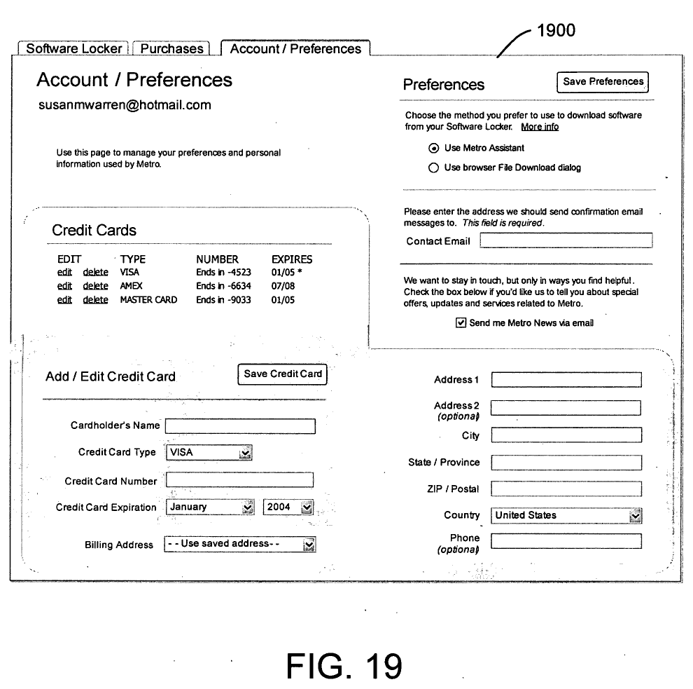

FIG. 19 is an example screenshot 1900 of a user interface provided by a multi-merchant purchasing system for a user to manage an account on the system. The user may provide and manage information required for making purchases. When making a purchase with downloadable products from multiple merchants, the provided information is forwarded to each merchant so that the user does not have to go through the purchasing process with each merchant.

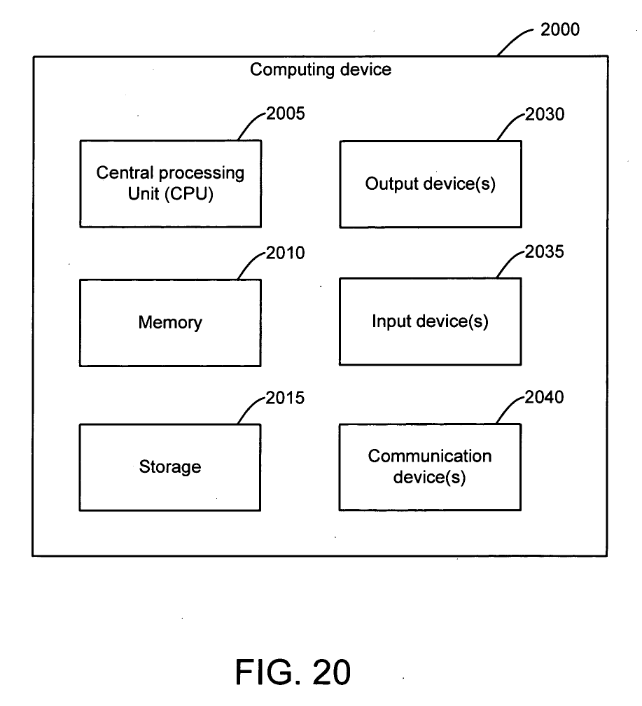

FIG. 20 shows an exemplary computer device 2000 for implementing the described systems and methods. In its most basic configuration, computing device 2000 typically includes at least one central processing unit (CPU) 2005 and memory 2010.

Depending on the exact configuration and type of computing device, memory 2010 may be volatile (such as RAM), non-volatile (such as ROM, flash memory, etc.) or some combination of the two. Additionally, computing device 2000 may also have additional features/functionality. For example, computing device 2000 may include multiple CPU's. The described methods may be executed in any manner by any processing unit in computing device 2000. For example, the described process may be executed by both multiple CPU's in parallel.

Computing device 2000 may also include additional storage (removable and/or non-removable) including, but not limited to, magnetic or optical disks or tape. Such additional storage is illustrated in FIG. 20 by storage 2015. Computer storage media includes volatile and nonvolatile, removable and non-removable media implemented in any method or technology for storage of information such as computer readable instructions, data structures, program modules or other data. Memory 2010 and storage 2015 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 2000. Any such computer storage media may be part of computing device 2000.

Computing device 2000 may also contain communications device(s) 2040 that allow the device to communicate with other devices. Communications device(s) 2040 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 2000 may also have input device(s) 2035 such as keyboard, mouse, pen, voice input device, touch input device, etc. Output device(s) 2030 such as a display, speakers, printer, etc. may also be included. All these devices are well know in the art and need not be discussed at length.

The multi-merchant purchasing environment for downloadable products discussed above may be implemented with many different types of communication mechanisms. Some example mechanisms are described below. These communication mechanisms include interfaces that may be implemented by a multi-merchant purchasing system and merchant services, such as multi-merchant purchasing system 100 and merchant services 131-133 shown in FIG. 1. The following interfaces may be implemented with any communication protocols, such as Simple Object Access Protocol (SOAP) for web services.

A. Merchant Service Interfaces

Merchant services, such as distribution partners, may implement the following interfaces to interact with a multi-merchant purchasing system.

1. Get Item Metadata Interface

Metadata associated with an item is used by the multi-merchant purchasing system to handle the item. For example, the metadata may be used in a shopping cart utility and a product locker, such as purchasing module 103 and locker module 105 shown in FIG. 1. Typically, the metadata may contain too much data to be efficiently obtained through a location associated with a URL. Also, such a mechanism may not provide a communication medium with the desired security level. The multi-merchant purchasing system may be configured to call the merchant services to obtain the metadata and to cache the metadata for use by multiple users.

The metadata required to display an item in the shopping cart and locker is more than is reasonable to place directly on the URL associated with adding an item to the cart. In addition, the URL is a fundamentally insecure communication medium. Because metadata may be cached for use by multiple users, there is a potential for abuse if the content from the URL is directly trusted. The multi-merchant purchasing system may be configured to call the merchant services to obtain details about each item.

The code below shows an example get item metadata interface that may be implemented in a merchant service and called by the multi-merchant purchasing system:

<complexType name=″ESD_ITEM_METADATA″>

<sequence>

<element name=″name″

type=″mtypes:string128″ />

<element name=″description″

type=″mtypes:string255″ />

<element name=″dl_format″

type=″mtypes:dlformat″ />

<element name=″dl_size_kb″

type=″integer″ />

<element name=″dl_item_count″

type=″integer″ />

<element name=″details_url″

type=″mtypes:URL″ />

<element name=″image_url″

type=″mtypes:URL″ minOccurs=″0″ />

<element name=″max_quantity″

type=″integer″ minOccurs=″0″ />

<element name=″winmp_id″

type=″mtypes:string64″ minOccurs=″0″ />

<element name=”dlformat_extension”

type=”string” minOccurs=”0” />

<element name=”extended_data_request”

Type=”string” minOccurs=”0” />

</sequence>

</complexType>

The interface specifies metadata that may be provided by a merchant service for a particular item handled by the multi-merchant purchasing system. The metadata includes the name, description and download format. The metadata may also include the download size, item count, a URL where details about the item can be found, a URL with images of the item, the maximum quantity available, and an identifier. The metadata may further include a download format extension and an extended data request. The optional “extended_data_request” field instructs the multi-merchant purchasing system to collect additional information from the user when purchasing the item.

The download format may be provided by the merchant service to identify the format of the installation package files. The download format metadata may include the following:

<simpleType name=“dlformat”>

<restriction base=“string”>

<enumeration value=“iso” />
<enumeration value=“se-exe” />
<enumeration value=“raw-exe” />
<enumeration value=“msi” />
<enumeration value=“None” />
<enumeration value=“use-extension” />
<enumeration value=“show-folder” />

</restriction>

</simpleType>

If the merchant service sends the special dlformat “use-extension”, the multi-merchant purchasing system may be configured to make a guess as to the “real” dlformat, based on the value provided in the “dlformat_extension” field of the ESD_ITEM_METADATA structure. The “dlformat_extension” field is typically included when a “use-extension” is sent. The default behavior if the extension is not recognized is “show-folder”. The “extended_data_request” field may be included to instruct the multi-merchant purchasing system to collection additional information from the user when purchasing the item.

The message to call the get item metadata interface may be specified by:

<message name=“DP_GetItemMetadataRequest”>

<part name=“dp_itemid” type=“mtypes:ESD_DP_ITEMID” />

</message>

The message to respond to the get item metadata request may be specified by:

<message name=“DP_GetItemMetadataResponse”>

<part name=“result” type=“mtypes:ESD_RESULT” />
<part name=“metadata”
type=“mtypes:ESD_ITEM_METADATA” />

</message>

The acceptable result codes for this function may include ok, invalid-input, transient-failure, or general-failure.

2. Get Summary Data Interface

When a user opts to complete the checkout process, calls may be made to the merchant services so that the multi-merchant purchasing system can provide a summary of the pending purchase, including subtotal and tax information. The merchant services typically verify that the data is acceptable for the purchase. For example, the merchant services may verify that the currency code is supported, the billing address is acceptable, the items in the shopping cart are valid and priced correctly, or the like.

The code below shows an example get summary data interface:

<complexType name=“ESD_BILLING_ADDRESS”>

<sequence>

<element name=“street_address_1”

type=“mtypes:string128” />

<element name=“street_address_2”

type=“mtypes:string128” minOccurs=“0” />

<element name=“city”

type=“mtypes:string128” />

<element name=“state”

type=“mtypes:string128” />

<element name=“postal_code”

type=“mtypes:string64” />

<element name=“country”

type=“mtypes:iso3166CountryCode” />

<element name=“phone”

type=“mtypes:string32” />

<element name=“vat_id”

type=“mtypes:string16” />

</sequence>

</complexType>
<complexType name=“ESD_CART_ITEM”>

<sequence>

<element name=“dp_itemid”

type=“mtypes:ESD_DP_ITEMID” />

<element name=“quoted_unit_price”

type=“decimal” />

<element name=“quantity”

type=“positiveInteger” />

</sequence>

</complexType>
<complexType name=“ESD_ITEM_TOTAL”>

<sequence>

<element name=“dp_itemid”

type=“mtypes:ESD_DP_ITEMID” />

<element name=“verified_unit_price”

type=“decimal” />

<element name=“quantity”

type=“positiveInteger” />

<element name=“line_total ”

type=“decimal” />

<element name=“line_tax”

type=“decimal” />

</sequence>

</complexType>

As shown by the code, both individual and total values are typically returned from this call. Each item may be identified by an identifier. The unit price, quantity, line total and tax information may be provided by the merchant service associated with the items.

The message to call the get summary data interface may be specified by:

message name=″DP_GetCartTotalsRequest″>

<part name=″user_id″ type=″mtypes:ESD_EXTUSERID″ />
<part name=″billing_address″
type=″mtypes:ESD_BILLING_ADDRESS″

/>

<part name=″currency_code″
type=″mtypes:iso4217CurrencyCode″

/>

<part name=″items″ type=″mtypes:ArrayOfESD_CART_ITEM″ />
<part name=”extended_data_result” type=”xsd:string”
minOccurs=”0”

/>
</message>

The message to respond to the get summary data request may be specified by:

<message name=“DP_GetCartTotalsResponse”>

<part name=“result” type=“mtypes:ESD_RESULT” />
<part name=“subtotal” type=“xsd:decimal” />
<part name=“total_tax” type=“xsd:decimal” />
<part name=“item_totals”
type=“mtypes:ArrayOfESD_ITEM_TOTAL” />

</message>

The acceptable result codes for this function may include ok, invalid-input, invalid-prices, invalid-quantities, transient-failure, or general-failure. An “invalid-prices” result code may indicate a success case for this function. A response with that code is expected to contain valid item totals. The multi-merchant purchasing system typically does not rely on data with other invalid and failure return codes. The optional “extended_data_result” field contains additional data collected by multi-merchant purchasing system from the user on behalf of the merchant service.

3. Purchasing Interface

After the user reviews the confirmation page and submits the transaction, the multi-merchant purchasing system may make purchasing calls to one or more merchant services associated with items in the shopping cart. The merchant services typically review the information for validity. At this point, the user has agreed to the information transfer. Thus, the merchant services may store the data associated with credit card and other personal information as needed.

The code below shows an example purchasing interface:

<complexType name=“ESD_ITEM_LICENSE”>

<sequence>

<element name=“dp_itemid”

type=“mtypes:ESD_DP_ITEMID” />

<element name=“transaction_id”

type=“mtypes:string64” />

<element name=“amount_paid”

type=“decimal” />

<element name=“tax_paid”

type=“decimal” />

<element name=“license_type”

type=“mtypes:lictype” />

<element name=“license_key” minOccurs=“0”

type=“string” />

</sequence>

</complexType>

There may be more ESD_ITEM_LICENSE elements returned than ESD_ITEM_TOTAL elements sent, if any quantity field is greater than one. A separate transaction ID may be requested for each item purchased. The merchant services may store what information they require.

The message to call the purchasing interface may be specified by:

<message name=“DP_ChargeCustomerRequest”>

<part name=“user_id” type=“mtypes:ESD_EXTUSERID” />
<part name=“user_email” type=“mtypes:string128”
minOccurs=“0” />
<part name=“user_name_first” type=“mtypes:string128”

minOccurs=“0” />

<part name=“user_name_last” type=“mtypes:string128”

minOccurs=“0” />

<part name=“user_ip” type=“mtypes:string32” />
<part name=“cc_info” type=“mtypes:ESD_CC_INFO” />
<part name=“currency_code”
type=“mtypes:iso4217CurrencyCode”

/>

<part name=“subtotal” type=“xsd:decimal” />
<part name=“total_tax” type=“xsd:decimal” />
<part name=“item_totals”
type=“mtypes:ArrayOfESD_ITEM_TOTAL” />
<part name=“extended_data_result” type=“xsd:string”
minOccurs=“0”

/>
</message>

The message to respond to the purchasing request may be specified by:

<message name=″DP_ChargeCustomerResponse″>

<part name=″result″ type=″mtypes:ESD_RESULT″ />
<part name=”purchase_id” type=”mtypes:string64” />
<part name=”pending_purchase_msg” type=”xsd:string”

minOccurs=”0” />

<part name=″subtotal_charged″ type=″xsd:decimal″ />
<part name=″total_tax_charged″ type=″xsd:decimal″ />
<part name=″item_licenses″
type=″mtypes:ArrayOfESD_ITEM_LICENSE″

/>

<part name=″test_order″ type=″xsd:boolean″ />

</message>

The test_order field is set to true if a merchant service recognizes that this order is a system test performed by itself or an ISV. The acceptable result codes for this function may include ok, fraudulent, insufficient funds, export-violation, invalid-input, invalid-prices, invalid-quantities, transient-failure, general-failure, or purchase pending.

If the merchant service needs to perform manual review or other investigation of the order, it may return purchase-pending as the result. The purchases row will be created with pending status, but no license will be associated with it. The confirmation page will indicate that the order is being processed and include a merchant service provided message, if given. The merchant service may make a Metro_CompletePurchase call later to complete the purchase.

4. Get Download Location Interface

When the user initiates a download action, the multi-merchant purchasing system may make a download location call to merchant services to request download URL(s). User, transaction and license data may be sent along for the merchant services for verification.

The returned URL(s) may be fetched by the user's client directly (e.g. using BITS in the dlmgr case). The URLs may be secured or not at the merchant services' discretion based on the software in question and their relationships with their ISVs. Time to live (TTL) information is provided to reduce the number of rejected merchant service requests (e.g. if a download is paused and then resumed at a later date).

The software assistant, such as a download manager, can ensure validity of the downloaded bits by computing a hash of the downloaded files (if the package contains multiple files, the hash may be computed on the bits of all files laid end-to-end in the order returned by this function) and comparing it to a hash value specified for each URL. Alternatively, the merchant services can pass “true” for the callback parameter to defer computing of their hash and ask that verification be done with the DP_VerifyDownloadHash function. This is to support the case where download bits may be altered in the HTTP stream and a pre-computed hash may be unworkable. In this case, the string passed as the “hash” value is an opaque merchant service cookie that is sent along with the validation request. A merchant service may provide a hashtype of “none” to prevent any verification.

The code below shows an example get download location interface:

<simpleType name=“hashtype”>

<restriction base=“string”>

<enumeration value=“none” />
<enumeration value=“md5” />

</restriction>

</simpleType>

The message to call the get download location interface may be specified by:

<message name=“DP_GetDownloadURLRequest”>

<part name=“user_id” type=“mtypes:ESD_EXTUSERID” />
<part name=“item_license”
type=“mtypes:ESD_ITEM_LICENSE” />
<part name=“ip_address” type=“xsd:string” />

</message>

The message to respond to the get download location request may be specified by:

<message name=“DP_GetDownloadURLResponse”>

<part name=“result” type=“mtypes:ESD_RESULT” />
<part name=“ttl-seconds” type=“xsd:integer” />
<part name=“hash_type” type=“mtypes:hashtype” />
<part name=“hash” type=“mtypes:string” />
<part name=“callback” type=“boolean” />
<part name=“urls” type=“mtypes:ArrayOfURL” />

</message>

The acceptable result codes for this function may include ok, invalid-input, transient-failure, or general-failure.

5. Get Support Location Interface

When the user initiates a support request from the locker, the multi-merchant purchasing system may make this call to request a URL to provide user support for the items purchased. User, transaction and license data may be sent along for the merchant services for verification.

The returned URL may be fetched by the user's client directly. The URL may be secured or not at the merchant services' discretion based on the software in question and their relationships with their ISVs. The merchant services may assume that the user has been authenticated properly by the multi-merchant purchasing system. A TTL may not be specified on the returned URL because there may be an immediate redirect.

The code below shows an example get support location interface:

<simpleType name=“supportpurpose”>

<restriction base=“string”>

<enumeration value=“receipt” />
<enumeration value=“return” />
<enumeration value=“other” />

</restriction>

</simpleType>

The message to call the support location interface may be specified by:

<message name=″DP_GetSupportURLRequest″>

<part name=”purpose” type=”mtypes:supportpurpose” />
<part name=″user_id″ type=″mtypes:ESD_EXTUSERID″ />
<part name=″ip_address″ type=″xsd:string″ />
<part name=″purchase_id″ type=″mtypes:string64″ />
<part name=″item_licenses″
type=″mtypes:ArrayOfESD_ITEM_LICENSE″

/>
</message>

The message to respond to the support location request may be specified by:

<message name=“DP_GetSupportURLResponse”>

<part name=“result” type=“mtypes:ESD_RESULT” />
<part name=“url” type=“mtypes:URL” />

</message>

The acceptable result codes for this function may include ok, invalid-input, transient-failure, or general-failure.

6. Get Download Verification Data Interface

In some cases, it may be difficult to pre-compute a hash for downloaded items. Some licensing technologies actually modify the bits in transit through the download server, injecting codes or registration data. For these cases, the computed hash value may be sent to the merchant services after the download has been completed, along with an opaque cookie that is provided. The merchant services may then perform the comparison.

The message to call the download verification data interface may be specified by:

<message name=“DP_VerifyDownloadHashRequest”>

<part name=“user_id” type=“mtypes:ESD_EXTUSERID” />

<part name=“hash_type” type= type=“mtypes:hashtype” />

<part name=“cookie” type= type=“xsd:string” />
<part name=“computed_hash” type= type=“xsd:string” />

</message>

The message to respond to the download verification data request may be specified by:

<message name=“DP_VerifyDownloadHashResponse”>

<part name=“result” type=“mtypes:ESD_RESULT” />

</message>

The acceptable result codes for this function may include ok, hash-mismatch, invalid-input, transient-failure, or general-failure.

B. Multi-Merchant Purchasing System Interfaces

A multi-merchant purchasing system may implement the following interfaces to interact with merchant services.

1. Revoke License Interface

If for any reason a user no longer has rights to a certain license, a merchant service may call this interface to inform the multi-merchant purchasing system about the revocation so the system can remove the license from the locker.

Enough data should be included in the call to uniquely identify the license. If the merchant service has assigned a unique transaction_id to each license, including this identifier is typically sufficient. However, if the transaction_id is not included, a license_key may be provided. An error may occur if more than one license is returned when executing the query.

The message to call the revoke license interface may be specified by:

<message name=“METRO_RevokeLicenseRequest”>

<part name=“dpid” type=“mtypes:ESD_DPID” />
<part name=“transaction_id” type=“mtypes:string64” />
<part name=“license_key” type=“xsd:string” minOccurs=“0” />
<part name=“reason” type=“mtypes:revokereason” />

</message>

The message to respond to the revoke license request may be specified by:

<message name=“METRO_RevokeLicenseResponse”>

<part name=“result” type=“mtypes:ESD_RESULT” />

</message>

The acceptable result codes for this function may include ok, invalid-input, transient-failure, or general-failure. In the case that the referenced license is not found in the multi-merchant purchasing system, the result code may be invalid-input.

2. Complete Purchase Interface

If merchant services reply to a DP_ChargeCustomer call with a purchase-pending result, the merchant services may be responsible for calling METRO_CompletePurchase as soon as possible to complete the purchase.

The message to call the complete purchase interface may be specified by:

<message name=“METRO_CompletePurchaseRequest”>

<part name=“dpid” type=“mtypes:ESD_DPID” />
<part name=“purchase_id” type=“mtypes:string64” />
<part name=“result” type=“mtypes:ESD_RESULT” />
<part name=“subtotal_charged” type=“xsd:decimal” />
<part name=“total_tax_charged” type=“xsd:decimal” />
<part name=“item_licenses”
type=“mtypes:ArrayOfESD_ITEM_LICENSE”

/>

<part name=“failed_purchase_msg” type=“xsd:string”
minOccurs=“0”

/>
</message>

The message to respond to the complete purchase request may be specified by:

<message name=“METRO_CompletePurchaseResponse”>

<part name=“result”
type=“mtypes:ESD_RESULT” />

</message>

The inbound result parameter may indicate the result of the investigation. The acceptable result codes for this function may include ok, fraudulent, insufficient funds, invalid-input, transient-failure, export-violation, or general-failure.

3. Add to Locker Interface

The merchant services may call this interface to insert licenses into the locker outside of the normal experience of the multi-merchant purchasing system. For example, this can be used to integrate the download experience for products purchased through a third-party retail experience.

The message to call the add to locker interface may be specified by:

<message name=“METRO_AddToLockerRequest”>

<part name=“puid” type=“xsd:string” />
<part name=“item_license”
type=“mtypes:ESD_ITEM_LICENSE” />

</message>

The message to respond to the add to locker request may be specified by:

<message name=“METRO_AddToLockerResponse”>

<part name=“result” type=“mtypes:ESD_RESULT” />

</message>

The acceptable result codes for this function may include ok, invalid-input, transient-failure, or general-failure.

FIG. 21 illustrates example communications 2100 between a multi-merchant purchasing system and merchant services. Communication 2100 may be used for the multi-merchant purchasing system to call interfaces implemented by a merchant service.

To obtain information about an item in a shopping cart, the multi-merchant purchasing system may send message 2102 that includes a get item metadata call to the merchant service. The call may include an identifier associated with the item. In response, the merchant service may send message 2104 that contains metadata about the item, such as the name, description, download format, size, item count, URL of the details about the item, URL of the images of the item, maximum quantity, an identifier associated with the item, the download format extension, or the like.

When an intent to purchase items is established, such as executing a checkout by a user, the multi-merchant purchasing system may send message 2106 that includes a get summary data call to the merchant service. The call may include an identifier associated with the user, billing address of the user, a currency identifier, identifiers of the items to be purchased, quoted unit prices, quantity or the like. In response, the merchant service may send message 2108 including summary data, such as the items to be purchased, identifiers associated with the items, verified unit prices, quantity, subtotal, tax, total price, or the like.

When the user selects to purchase the items, the multi-merchant purchasing system may send message 2110 that includes a purchasing call to the merchant service. The call may include user identifier, user email, user name, currency identifier, subtotal, tax, total price, or the like. In response, the merchant service may send message 2112 containing purchasing data, such as a purchase identifier, a pending purchase message, subtotal charged, tax charged, item licenses, or the like.

After the purchase, the multi-merchant purchasing system may send message 2114 that includes a get download location call to the merchant service to obtain the location where each purchased item may be downloaded. The call may include a user identifier, license of the item, an IP address associated with the user. In response, the merchant service may send a message 2116 that includes a location, such as a URLs, a hash, type identifier associated with the hash, a time to live (TTL) of the location, or the like.

The multi-merchant purchasing system may send message 2118 that includes a get support location call to the merchant service to obtain the location where support for each purchased item may be obtained. The call may include a purpose identifier, a user identifier, an IP address associated with the user, a purchase identifier, license of the item, or the like. The merchant service may respond to the call by sending message 2120 that includes the support location.

If a merchant service is configured to provide the hash for verifying a downloaded item after purchase, the multi-merchant purchasing system may send message 2122 that includes a get download verification data call to the merchant service. The call may include a user identifier, an identifier for the type of the hash, a cookie, a computed hash, or the like. In response, the merchant service may send message 2124 that contains an identifier to indicate whether the item has been verified.

FIG. 22 illustrates further example communications 2200 between a multi-merchant purchasing system and merchant services. Communication 2200 may be used for a merchant service to call interfaces implemented by the multi-merchant purchasing system.

When a merchant service determines to revoke a license for a particular purchased item, the merchant service may send a message 2202 to the multi-merchant purchasing system that includes a revoke license call. The call may contain an identifier of the merchant service, a transaction identifier, a license key, an identifier of the reason for revocation, or the like. In response, the multi-merchant purchasing system may send message 2204 that contains an identifier to indicate whether the license has been revoked.

To complete a pending purchase, the merchant service may send message 2206 that includes a complete purchase call. The call may include a merchant service identifier, purchase identifier, subtotal charged, tax charged, item licenses, failed purchase message, or the like. In response, the multi-merchant purchasing system may send message 2208 that contains an identifier to indicate whether the purchase has been confirmed.

To insert licenses for purchased items associated with a user, the merchant service may send a message 2210 that includes an add-to-locker call. The call may include a user identifier, item licenses, or the like. In response, the multi-merchant purchasing system may send message 2204 that contains an identifier to indicate whether the licenses have been accepted.

While the preferred embodiment of the invention has been illustrated and described, it will be appreciated that various changes can be made therein without departing from the spirit and scope of the invention.

1) One or more device-readable media having device-executable instructions for performing steps comprising:
identifying downloadable products for purchasing by a user, the downloadable products being offered by multiple merchants;
presenting a user-interface for purchasing the downloadable products from the multiple merchants with a single transaction;
determining payment information associated with the user;
providing the payment information to each of the merchants for processing, without interacting with the user;
receiving purchasing information from each of the merchants, the purchasing information including licenses for each of the purchased products; and
enabling the purchased products to be downloaded.

2) The one or more device-readable media recited in claim 1, wherein the steps further comprising:
retrieving updated product information about the downloadable products from the services associated with each merchant; and
providing the updated product information to the user prior to providing the payment information to the merchants.

3) The one or more device-readable media recited in claim 1, wherein the steps further comprising requesting authorization from the user prior to providing the payment information to the merchants.

4) The one or more device-readable media recited in claim 1, wherein the steps further comprising retrieving the payment information from a data store, without prompting the user for the information.

5) The one or more device-readable media recited in claim 1, wherein the steps further comprising:
requesting an authentication service to authenticate the user; and
if the user is not authenticated, preventing the user from purchasing the downloadable products.

6) The one or more device-readable media recited in claim 1, wherein the steps further comprising if the user is authenticated, receiving account information associated with the user from the authentication service.

7) A computing device configured to read the one or more device-readable media and perform the steps as recited in claim 1.

8) An apparatus configured with means to perform the steps as recited in claim 1.

9) A system for purchasing downloadable products comprising a purchasing module configured to receive a list of downloadable products that are provided by multiple merchants, the list of downloadable products being identified to be purchased by a user, the purchasing module also configured to present a user-interface for purchasing the downloadable products in a single transaction and to determine payment information associated with the user, the purchasing module further configured to provide the payment information to a service associated with each merchant and to receive purchasing information about the purchased products from services.

10) The system as recited in claim 9, further comprising an authentication system configured to authenticate the user and provide confirmation to the purchasing module.

11) The system as recited in claim 9, wherein the purchasing module includes an interface for interacting with a catalog provider configured to enable the user to select the downloadable products provided by the multiple merchants and to send the list of downloadable products to the purchasing module.

12) The system as recited in claim 9, further comprising a software assistant configured to receive instructions for downloading the purchased products from the purchasing module and to download the purchased products onto a computing device associated with the user.

13) The system as recited in claim 9, further comprising a data store, wherein the purchasing module is configured to store the purchasing information in the data store.

14) The system as recited in claim 13, wherein the purchasing module is configured to retrieve the payment information from a data store, without requesting the information from the user.

15) The system as recited in claim 9, wherein the downloadable products include at least one of downloadable digital content, software, music, videos, or graphics.

16) The system as recited in claim 9, wherein the merchants include at least one of producers of the downloadable products, online retailers, resellers, or catalog providers.

17) A computer-implemented method for purchasing downloadable digital content comprising:
determining software products offered by multiple merchants, the software products being selected by a user through a shopping application;
providing a user-interface for purchasing the selected software products with a single transaction;
in response to a selection to purchase the software products, determining payment information associated with the user;
sending the payment information to merchant applications, each of the applications being associated with at least one of the merchants;
receiving purchasing information from each of the merchant applications; and
providing the purchasing information to the user.

18) The computer-implemented method as recited in claim 17, further comprising retrieving from a data store the payment information provided in a prior transaction.

19) The computer-implemented method as recited in claim 17, further comprising authenticating the user before sending the payment information to the merchant applications.

20) One or more device-readable media encoded with a computer-executable component configured to perform the computer-implemented method as recited in claim 17.
